(19) United States
(12) Patent Application Publication
(10) Pub. No.: US 2016/0364600 A1
(43) Pub. Date: Dec. 15, 2016

(54) Biometric Gestures

(71) Applicant: Microsoft Technology Licensing, LLC, Redmomd, WA (US)

(72) Inventors: Akash Atul Shah, Redmond, WA (US); Peter Dawoud Shenouda Dawoud, Redmond, WA (US); Nelly Porter, Kirkland, WA (US); Himanshu Soni, Bothell, WA (US); Michael E. Stephens, Marysville, WA (US)

(21) Appl. No.: 14/735,907

(22) Filed: Jun. 10, 2015

(51) Int. Cl. G06K 9/00; G06F 21/32

(52) U.S. Cl. CPC G06K 9/00087; G06K 9/00892; G06K 9/00288; G06K 9/00013; G06F 21/32

(57) ABSTRACT

Techniques and apparatuses for biometric gestures are described herein. In one or more implementations, a computing device includes a biometric sensor, such as a fingerprint touch sensor, that is configured to detect gesture input. When gesture input is received from a user, the biometric sensor detects biometric characteristics (e.g., a fingerprint) of the user and determines a gesture (e.g., a tap, touch and hold, or swipe) based on the gesture input. The user is authenticated if the biometric characteristics correspond to an authorized user of the device. If the user is authenticated, the device transitions to an authenticated user state that is associated with the type of gesture, such as by displaying personal information on a lockscreen of the computing device or opening a quick action center.

### BACKGROUND

Many conventional devices, such as wireless phones and tablets, can be configured to display a lockscreen user interface when the device is in a locked state. To unlock the device, a user may enter a password or provide biometric input (e.g., a fingerprint) that can be used to verify the user's identity as an authorized user of the device. Conventional devices interpret biometric input as intent to authenticate and unlock the device. Doing so, however, enables just two device states, a locked state where access to the device is prevented, and an unlocked state in which access to the device is allowed.

The lockscreen can be used to provide many useful functionalities to the user and to enable quick access to personal information, such as text message notifications, social media updates, and meeting reminders. When the device is equipped with just a locked state and an unlocked state, however, the user must choose whether to allow some personal information and notifications to be visible on the lockscreen regardless of who is using the device, or to prevent the display of any personal information on the lockscreen which provides for a more private user experience but excludes many useful functionalities available on the lockscreen.

### SUMMARY

Techniques and apparatuses for biometric gestures are described herein. In one or more implementations, a computing device includes a biometric sensor, such as a fingerprint touch sensor, that is configured to detect gesture input. When gesture input is received from a user, the biometric sensor detects biometric characteristics (e.g., a fingerprint) of the user and determines a gesture (e.g., a tap, touch and hold, or swipe) based on the gesture input. The user is authenticated if the biometric characteristics correspond to an authorized user of the device. If the user is authenticated, the device transitions to an authenticated user state that is associated with the type of gesture, such as by displaying personal information on a lockscreen of the computing device or opening a quick action center.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The same numbers are used throughout the drawings to reference like features and components.

FIG. 1 is an illustration of an environment in an example implementation that is operable to support techniques described herein.

FIG. 2 illustrates a system in which a controller initiates a transition from a locked state to an authenticated user state based on gesture input.

FIG. 3 illustrates an example of transitioning to an authenticated user state by displaying personal information on a lockscreen in accordance with one or more implementations.

FIG. 4 illustrates an example of transitioning to an authenticated user state by opening a quick action center in accordance with one or more implementations.

FIG. 5 illustrates an example method of initiating an authenticated user state.

FIG. 6 illustrates an example method of displaying personal information on a lockscreen based on gesture input.

FIG. 7 illustrates an example system that includes an example computing device that is representative of one or more computing systems and/or devices that may implement the various techniques described herein.

### DETAILED DESCRIPTION

Overview

Techniques and apparatuses for a biometric gestures are described herein. In one or more implementations, a computing device includes a biometric sensor, such as a fingerprint touch sensor, that is configured to detect gesture input. When gesture input is received from a user, the biometric sensor detects biometric characteristics (e.g., a fingerprint) of the user and determines a gesture (e.g., a tap, hold, or swipe) based on the gesture input. The user is authenticated if the biometric characteristics correspond to an authorized user of the device. If the user is authenticated, the device transitions to an authenticated user state that is associated with the type of gesture, such as by displaying personal information on a lockscreen of the computing device or opening a quick action center.

The computing device may be configured with multiple different authenticated user states that are each mapped to a different gesture type. Doing so enables the user to quickly and easily navigate to different authenticated user states by providing gesture input to the biometric sensor. For example, the computing device can transition to a first authenticated user state if the gesture input corresponds to a first gesture type, transition to a second authenticated user state if the gesture input corresponds to a second gesture type, and so forth.

In one or more implementations, the computing device is configured to display a lockscreen while the computing device is in a locked state that prevents access to the computing device. In the locked state, the lockscreen does not display any personal information, such as text message notifications, social media updates, and meeting reminders. Currently when users authenticate using a biometric sensor, their touch is interrupted as an intent to authenticate and unlock the device. Thus, if the device is set to require authentication to display private information on the lockscreen, users will not be able to use this gesture as a mechanism to view their personal data or information since the gesture will also dismiss the lock screen.

Techniques described herein, however, enable the user to quickly transition to an authenticated user state to view personal information on the lockscreen, without unlocking the device, by providing gesture input to the lockscreen. The biometric sensor prevents the gesture input from initiating the display of the personal information for users other than the authorized user of the computing device. This enables the user to have a private experience on the device, while still being able to quickly access personal information on the lockscreen.

Example Environment

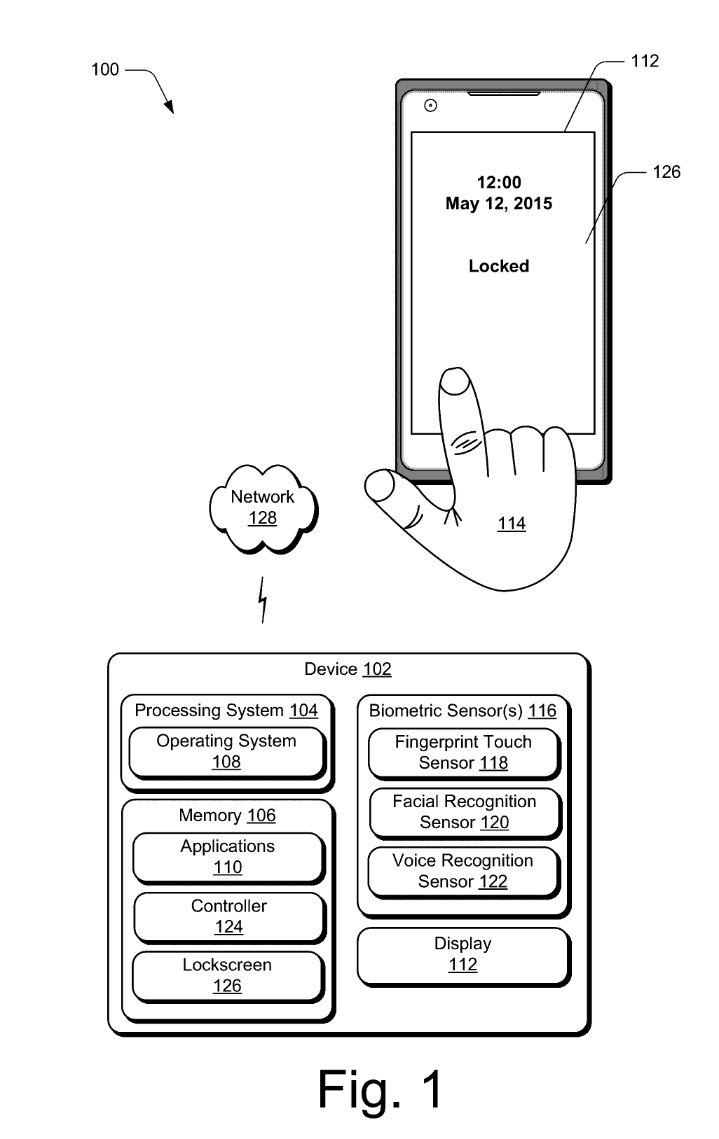

FIG. 1 is an illustration of an environment 100 in an example implementation that is operable to support techniques described herein. The illustrated environment 100 includes a computing device 102 (device 102) having one or more hardware components, examples of which include a processing system 104 and a computer-readable storage medium that is illustrated as a memory 106 although other components are also contemplated as further described below.

In this example, device 102 is illustrated as a wireless phone. However device 102 may be configured in a variety of ways. For example, device 102 may be configured as a computer that is capable of communicating over a network, such as a desktop computer, a mobile station, an entertainment appliance, a set-top box communicatively coupled to a display device, a game console, educational interactive devices, point of sales devices, wearable devices (e.g., a smart watch and a smart bracelet) and so forth. Thus, device 102 may range from full resource devices with substantial memory and processor resources (e.g., personal computers, game consoles) to a low-resource devices with limited memory and/or processing resources (e.g., traditional set-top boxes, hand-held game consoles).

Device 102 is further illustrated as including an operating system 108, although other embodiments are also contemplated in which an operating system is not employed. Operating system 108 is configured to abstract underlying functionality of device 102 to applications 110 that are executable on device 102. For example, operating system 108 may abstract processing system 104, memory 106, and/or network functionality of device 102 such that the applications 110 may be written without knowing “how” this underlying functionality is implemented. Application 110, for instance, may provide data to operating system 108 to be rendered and displayed without understanding how this rendering will be performed. Operating system 108 may also represent a variety of other functionality, such as to manage a file system and user interface that is navigable by a user of device 102.

Device 102 is further illustrated as including a display 112 that can be controlled to render or display images for viewing. In environment 100, display 112 is illustrated as an integrated component of device 102. Alternatively, display 112 can be implemented as an external, peripheral component to device 102. In one or more implementations, display 112 is implemented as a touchscreen display configured to receive gesture input, such as from a finger of a user's hand 114 a stylus or pen, and so forth. In one or more implementations, display 112 may be configured to receive touch-free gesture input, such as waving a hand or arm near the display 112. Display 112 can also receive input via other input devices, such as a mouse, a keyboard, video cameras, accelerometers, and so forth.

Device 102 further includes one or more biometric sensors 116 which are configured to receive gesture input from a user, and to both detect biometric characteristics of the user and determine a gesture based on the gesture input. Biometric sensors 116 can include any type of biometric sensor, including by way of example and not limitation, a fingerprint touch sensor 118, a facial recognition sensor 120, or a voice recognition sensor 122.

Fingerprint touch sensor 118 may be configured to receive gesture input to the entire area of display 112, or just a portion of display 112. Alternately, fingerprint touch sensor 118 may configured to receive gesture input to a dedicated fingerprint area or button proximate display 112.

When gesture input from a user is received, fingerprint touch sensor 118 can detect fingerprint characteristics of the gesture input that is useable to identify the user as an authorized user or owner of device 102. For example, the owner of device 102 may configure fingerprint touch sensor 118 to recognize the user's fingerprint by providing the user's fingerprint to fingerprint touch sensor 118 during a calibration stage. Thereafter, when the user provides gesture input by gesturing on fingerprint touch sensor 118, the fingerprint touch sensor recognizes the fingerprint as belonging to the user, and thus the user can be authenticated. Similarly, facial recognition sensor 120 and voice recognition sensor 122 may be configured to detect facial characteristics or voice characteristics, respectively, of the user that can be used to identify the user as the authorized user or owner of the device.

In addition to detecting biometric characteristics, biometric sensor 116 is configured to substantially concurrently recognize a gesture based on the gesture input. For example, while gesture input corresponding to a gesture (e.g., a tap, hold, or swipe) is being received from a user, fingerprint touch sensor 118 can substantially concurrently detect fingerprint characteristics of the user's finger and determine the gesture type. Notably, therefore, fingerprint touch sensor 118 can detect a gesture and biometric characteristics corresponding to a single user interaction with fingerprint touch sensor 118.

When implemented as a biometric sensor other than fingerprint touch sensor 118, biometric sensor 116 may include a touch sensor that detects gesture input which triggers the biometric sensor to detect biometric characteristics. For example, the gesture input may trigger facial recognition sensor 120 to detect facial characteristics or trigger voice recognition sensor 122 to detect voice characteristics.

Device 102 is further illustrated as including a controller 124 that is stored on computer-readable storage memory (e.g., memory 106), such as any suitable memory device or electronic data storage implemented by the mobile device. In implementations, controller 124 is a component of the device operating system.

Controller 124 is representative of functionality to initiate the transition to various authenticated user states, based on a type of the gesture detected by biometric sensor 116. The various authenticated user states may permit the user to perform different authenticated actions, such as opening an application, interacting with device functionality, or viewing personal information, such as text message notifications, missed calls, meeting reminders, and the like.

In one or more implementations, controller 124 is configured to initiate the transition to an authenticated user state from a locked state in which a lockscreen 126 is displayed on display 112. Lockscreen 126 can be configured to not display any personal information or notifications when device 102 is in the locked state. In FIG. 1, for example, lockscreen 126 displays the date and time, but does not display any personal information or notifications.

When gesture input is received, controller 124 can authenticate the user based on biometric characteristics of the user, and initiate the transition from lockscreen 126 to an authenticated user state based on the type of the gesture. For example, controller 124 can initiate a transition to a first authenticated user state if the gesture input corresponds to a first gesture type, initiate a transition to a second authenticated user state if the gesture input corresponds to a second gesture type, and so forth. Notably, at least one of the authenticated user states may include a state other than an unlocked state in which full access to device 102 is provided. For example, responsive to a receiving gesture input, device 102 may transition to an authenticated user state by displaying personal information on lockscreen 126 without unlocking device 102.

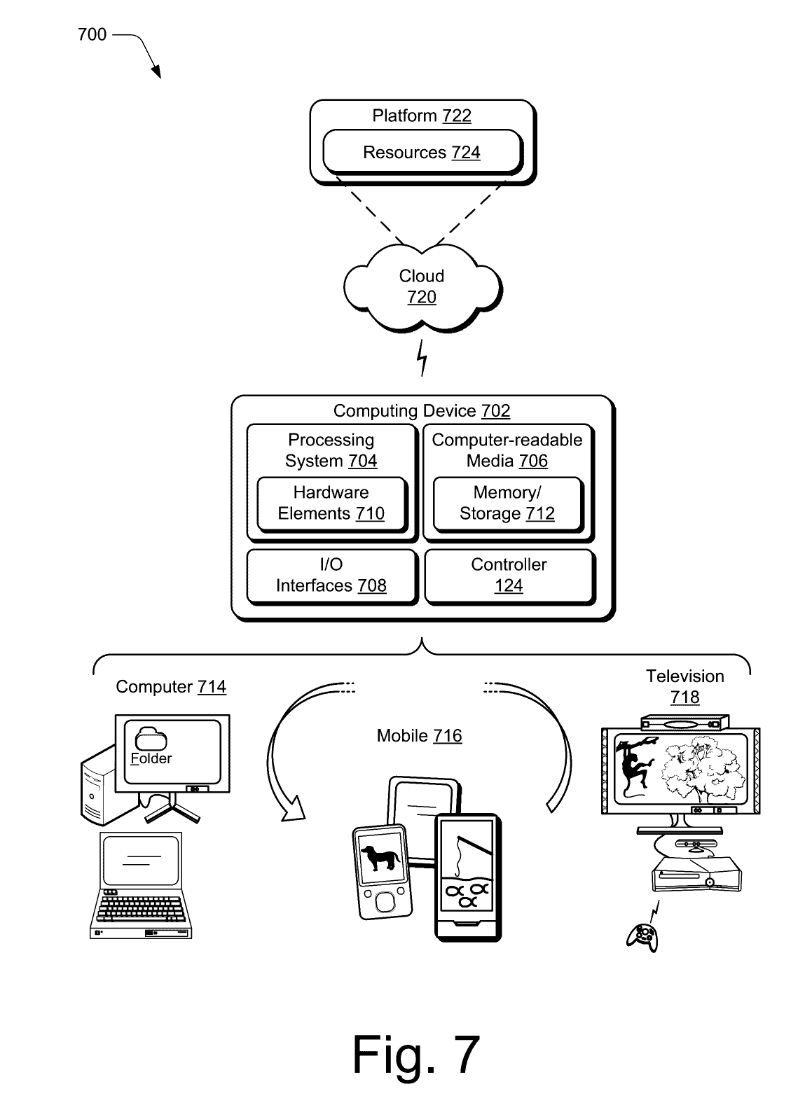

Although illustrated as part of device 102, functionality of controller 124 may also be implemented in a distributed environment, remotely via a network 128 (e.g., “over the cloud”) as further described in relation to FIG. 7, and so on. Although network 128 is illustrated as the Internet, the network may assume a wide variety of configurations. For example, network 128 may include a wide area network (WAN), a local area network (LAN), a wireless network, a public telephone network, an intranet, and so on. Further, although a single network 128 is shown, network 128 may also be configured to include multiple networks.

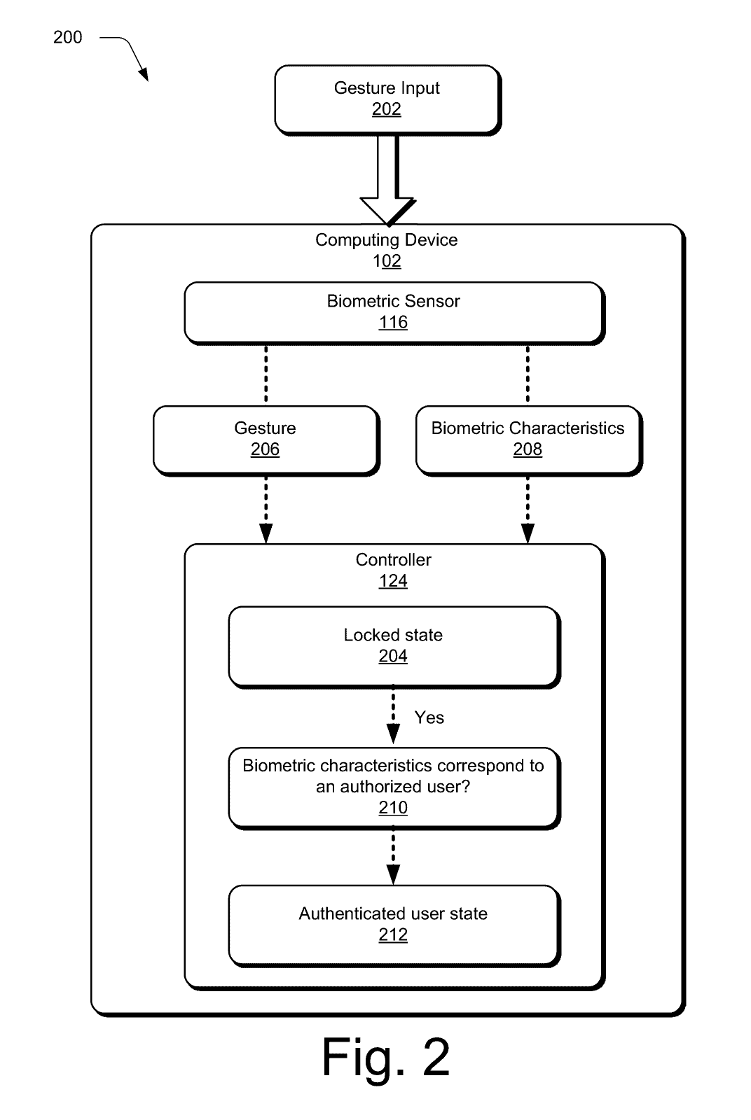

FIG. 2 illustrates a system 200 in which controller 124 initiates a transition from a locked state to an authenticated user state based on gesture input.

In system 200, device 102 receives gesture input 202 from a user when device 102 is in a locked state 204. As described herein, locked state 204 corresponds to any state in which access personal information, device functionality, or applications of device 102 is prevented.

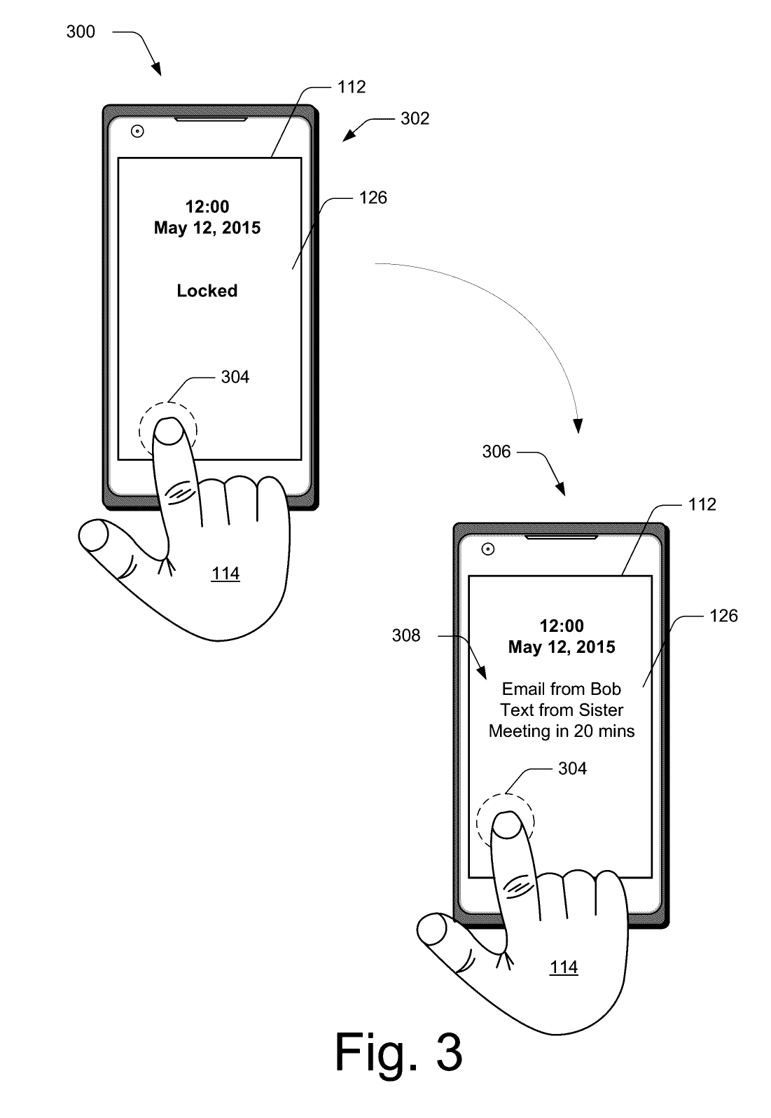

In some cases, lockscreen 126 is displayed on display 112 when device 102 is in locked state 204. As an example, consider FIG. 3 which illustrates an example 300 of transitioning to an authenticated user state by displaying personal information on a lockscreen in accordance with one or more implementations.

In example 300, display 112 of device 102 displays lockscreen 126 while device 102 is in a locked state 302. While device 102 is in locked state 302, users are unable to view personal information or access device functionality or applications of device 102. In FIG. 3, for example, lockscreen 126 displays time and date information, but does not display any personal information, such as text message notifications, missed calls, social media updates, meeting reminders, and so forth. Thus, if an unauthorized user picks up device 102, the user will be unable to view or access any personal information or data.

Gesture input 202 may correspond to any type of gesture, such as by way of example and not limitation, taps (e.g., single taps, double taps, or triple taps), a touch and hold, and swipes (e.g., swipe up, swipe down, swipe left, or swipe right). In addition, gesture input 202 may correspond to single or multi-finger gestures. In FIG. 3, for example, gesture input 304 is received when a finger of a user's hand 114 makes contact with display 112 while display 112 is displaying lockscreen 126.

Returning to FIG. 2, when gesture input 202 is received, biometric sensor 116 determines a gesture 206 corresponding to the gesture input. For example, biometric sensor 116 detects one or more touch characteristics of gesture input 202, such as a position of the gesture input, a duration of the gesture input, the number of fingers of the gesture input, or movement of the gesture input. The touch characteristics can be used to determine the type of gesture 206, such as a tap, touch and hold, or swipe. For example, in FIG. 3 fingerprint touch sensor 118 can determine that gesture input 302 corresponds to a “touch and hold” gesture because gesture input 302 corresponds to a single finger and is held for a certain period of time on fingerprint sensor 118.

In addition to determining gesture 206, biometric sensor 116 can substantially concurrently detect biometric characteristics 208 of the user while gesture input 202 is being received. For instance, in FIG. 3, fingerprint touch sensor 118 can detect one or more fingerprint characteristics of the finger of the user's hand 114 that makes contact with display 112. The fingerprint characteristics can be used to recognize the fingerprint of the user as belonging to an authorized user or owner of device 102. Similarly, when implemented as facial recognition sensor 120 or voice recognition sensor 122, biometric characteristic 208 may correspond to facial characteristics or voice characteristics, respectively, that can be used to recognize the user.

As described herein, gesture input 202 may begin as soon as the user touches, or is otherwise recognized by, biometric sensor 116. In some cases, for example, biometric sensor 116 may be able to recognize a hover gesture as the user hovers a finger over biometric sensor 116. Biometric sensor 116 can detect biometric characteristics 208 when gesture input 208 first begins, and/or any time during which the gesture input is being received. For example, fingerprint touch sensor 118 may detect one or more fingerprint characteristics of the finger of the user's hand 114 as soon as the finger touches biometric sensor 116 to begin the gesture, as well as any time during which gesture input 202 is being received. For example, during a swipe gesture, fingerprint touch sensor 118 may be able to detect fingerprint touch characteristics of the finger of the user's hand 114 when the swipe begins and/or during the entire duration in which the user is performing the swipe. Gesture input 202 may end as soon as the user discontinues the touching of biometric sensor 116 or is no longer recognized by biometric sensor 116.

Controller 124 receives an indication of the type of gesture 206 and biometric characteristics 208 from biometric sensor 116. At 210, controller 124 analyzes biometric characteristics 208 to determine whether biometric characteristics 208 correspond to an authorized user of device 102. In FIG. 3, for example, controller 124 compares the fingerprint characteristics received from fingerprint touch sensor 118 to determine whether the fingerprint characteristic match a fingerprint of the authorized user or owner of device 102.

If controller 124 determines that biometric characteristics 208 correspond to an authorized user of device 102, then controller 116 authenticates the user and initiates a transition to an authenticated user state 212 based on gesture 206. Alternately, if controller 124 determines that biometric characteristics 208 do not correspond to an authorized user of the device, then controller 124 does not authenticate the user and prevents the transition to the authenticated user state. For example, when the gesture is received when the device is locked, controller 124 may prevent the user from viewing personal information on lockscreen 126.

Device 102 may be configured with multiple different authenticated user states 212 that are each mapped to a different gesture 206. This enables the user to quickly and easily navigate to any number of different authenticated user states by providing gesture input to biometric sensor 116. For example, controller 124 can initiate a transition to a first authenticated user state if the gesture input corresponds to a first gesture type, initiate a transition to a second authenticated user state if the gesture input corresponds to a second gesture type, initiate a transition to a third authenticated user state if the gesture input corresponds to a third gesture type, and so forth.

In one or more implementations, at least one of the authenticated user states 212 causes display of personal information on lockscreen 126 without unlocking device 102. In FIG. 3, for example, the touch and hold gesture of gesture input 304 causes device 102 to transition to an authenticated user state 306 which causes display of personal information 308 on lockscreen 126. Personal information 308 includes the notifications “Email from Bob”, “Text from Sister”, and “Meeting in 20 minutes”. In this example, the gesture type that is associated with the transition to the authenticated user state 306 corresponds to a touch and hold gesture. However, it is to be understood that any type of gesture may be mapped to authenticated user state 306, such as a tap, double tap, swipe, and so forth.

Device 102 may remain in authenticated user state 212 for as long as the user is touching biometric sensor 116. For example, in FIG. 3 personal information 308 can be displayed on display 112 for as long as the finger of the user's hand 114 is touching fingerprint touch sensor 118. In one or more implementations, personal information 308 may remain displayed on lockscreen 126 for a predetermined period of time after the gesture input is received. In FIG. 3, for instance, after the user removes their finger from fingerprint sensor 118, device 102 may remain in authenticated user state 306 for a predetermined period of time by displaying personal information 308 on lockscreen 126.

After the transition to authenticated user state 212, the user may be able to quickly initiate the transition to different authenticated user states by providing additional gesture input to biometric sensor 116. For example, the user can provide additional gesture input to fingerprint sensor 118 during the period of time that computing device 102 is still in authenticated user state 212.

In one or more implementations, a first gesture causes the display of personal information on lockscreen 126, and a second gesture causes a transition to a quick action center that enables the user to interact with the personal information and/or perform quick actions.

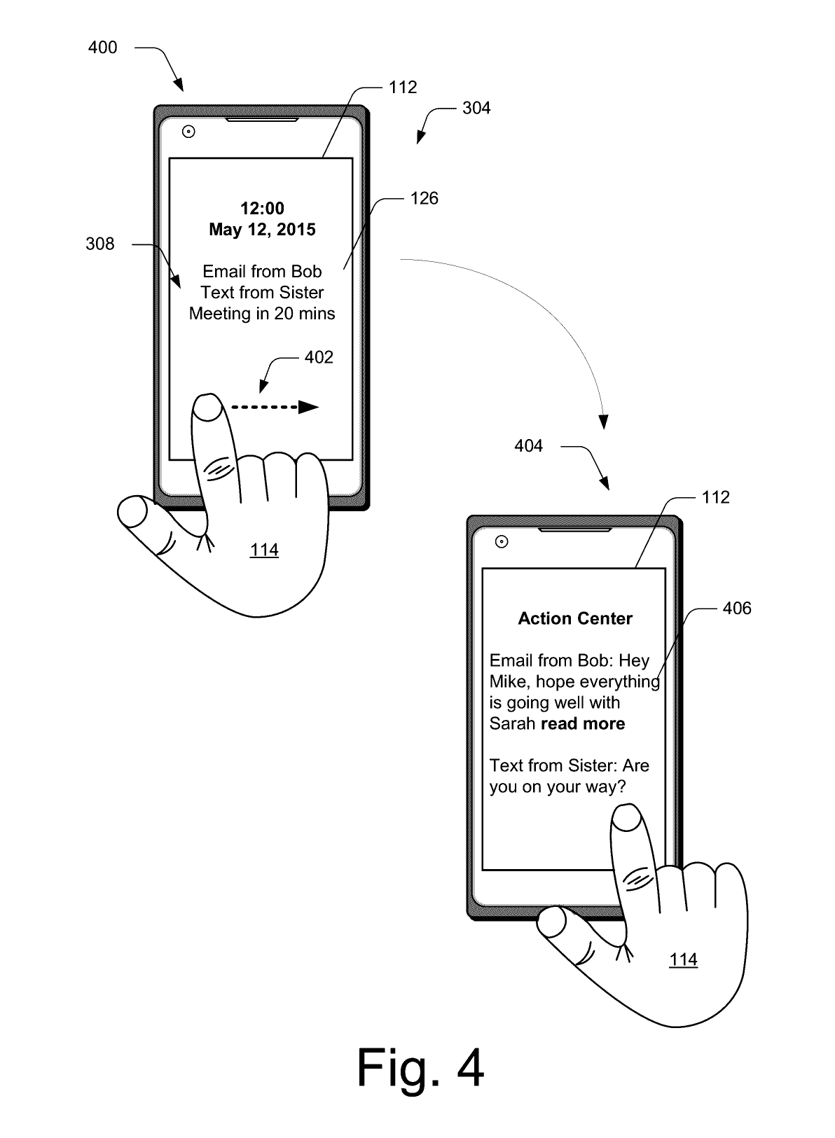

As an example, consider FIG. 4 which illustrates an example 400 of transitioning to an authenticated user state by opening a quick action center in accordance with one or more implementations.

In this example, after transitioning to authenticated user state 306, additional gesture input 402 is received, which corresponds to a swipe right. When gesture input 402 is received, controller 124 initiates a transition to an authenticated user state 404 by opening a quick action center 406. Quick action center 406 enables the user to take quick actions, such as reading recent emails, viewing calendar notifications, adjusting settings of the device (e.g., wireless settings, display brightness, or airplane mode), interacting with applications (e.g., music playing controls, launching a camera application, launching a note taking application), and so forth. In example 400, quick action center 406 displays a portion of the text of the email message from Bob and the text message from the user's sister.

In example 400, because the user was already authenticated based on gesture input 302, controller 124 may not need to “re-authenticate” the user when gesture input 402 is received by checking biometric characteristics of gesture input 402. However, if gesture input 402 were received prior to receiving gesture input 302, then controller 124 may first authenticate the user based on the biometric characteristics associated with gesture input 402.

In one or more implementations, controller 124 initiates the transition to authenticated user state 212 by unlocking device 102. For example, a gesture such as a “tap” may be mapped to unlocking device 102. Thus, whenever the user wishes to unlock device 102, the user can simply tap fingerprint sensor 118. However, if the user wants to perform a different action without unlocking device 102, such as displaying personal information on the lockscreen or opening the quick action center, then the user can quickly perform a different gesture, as discussed above.

In the examples discussed above, a touch and hold gesture can be associated with an authenticated device state that causes display of personal information 308 on lockscreen 126, a swipe gesture can be associated with an authenticated user state that opens a quick action center 406, and a tap gesture can be associated with an authenticated user state that unlocks device 102. It is to be understood, however, that any type of gesture may be associated with any of these different authenticated user states.

In addition multiple different types of authenticated user states 212 are contemplated. For instance, specific gestures may be mapped to specific device functionality or applications other than the examples described herein. For example, a swipe up could be mapped to an authenticated user state in which a camera application is launched, a swipe left could be mapped to an authenticated user state in which a note taking application is launched, and a double tap could be mapped to playing a next song on a music player application. Notably, since each of these gestures are sensed by biometric sensor 116, unauthorized users are prevented from accessing these different authenticated user states.

In one or more implementations, different authenticated user states can be configured based on a location or activity of device 102. For example, device 102 can be configured so that when device 102 is in the user's home, personal information is displayed on the lockscreen as a default state of the device. However, when device 102 is not at the user's home, the personal information is not displayed on the lockscreen until the touch and hold gesture is received from the user.

Example Method

The methods described herein are shown as sets of blocks that specify operations performed but are not necessarily limited to the order or combinations shown for performing the operations by the respective blocks. The techniques are not limited to performance by one entity or multiple entities operating on one device.

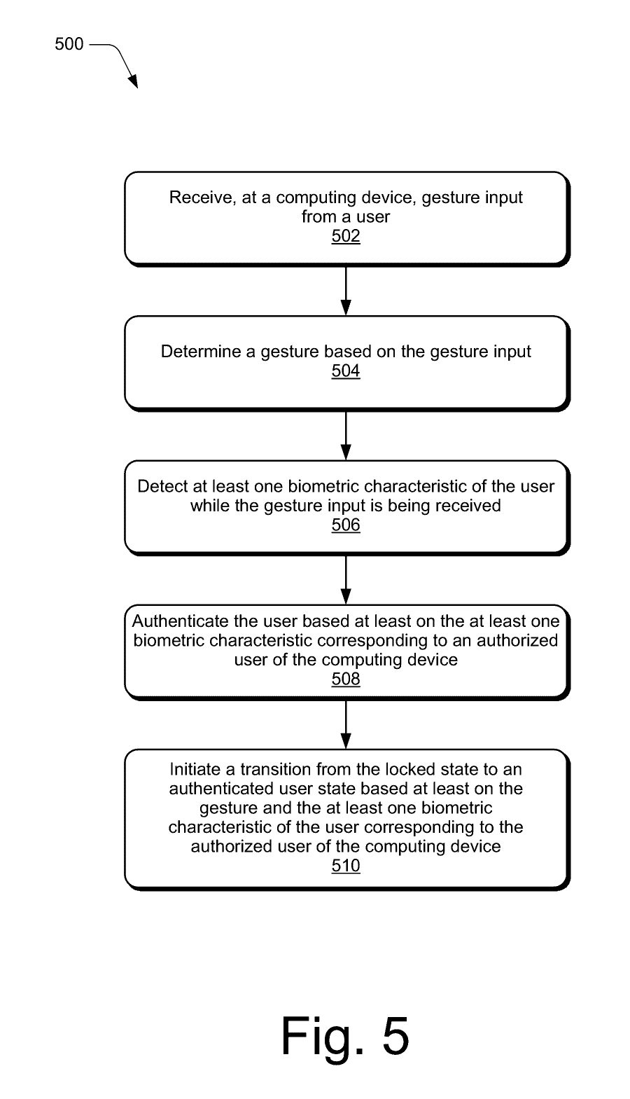

FIG. 5 illustrates an example method 500 of initiating an authenticated user state. At 502, gesture input is received at a computing device from a user. For example, biometric sensor 116, implemented at device 102, receives gesture input 202 from a user.

At 504, a gesture is determined based on the gesture input, and at 506 at least one biometric characteristic of the user is detected while the gesture input is being received. For example, biometric sensor 116 determines a gesture 206 based on gesture input 202, such as a tap, hold, or swipe, and detects biometric characteristics 208 of the user, such as fingerprint characteristics, facial characteristics, or voice characteristics.

At 508, the user is authenticated based at least on the at least one biometric characteristic corresponding to an authorized user of the computing device. For example, controller 124 compares biometric characteristics 208 to stored biometric characteristics associated with one or more authorized users of device 102. If a match is found, controller 124 authenticates the user as an authorized user of device 102.

At 510, a transition is initiated from the locked state to an authenticated user state based at least on the gesture and the at least one biometric characteristic of the user corresponding to the authorized user of the computing device. For example, if controller 124 authenticates the user at step 508, then controller 124 initiates a transition to authenticated user state 212 based on gesture 206.

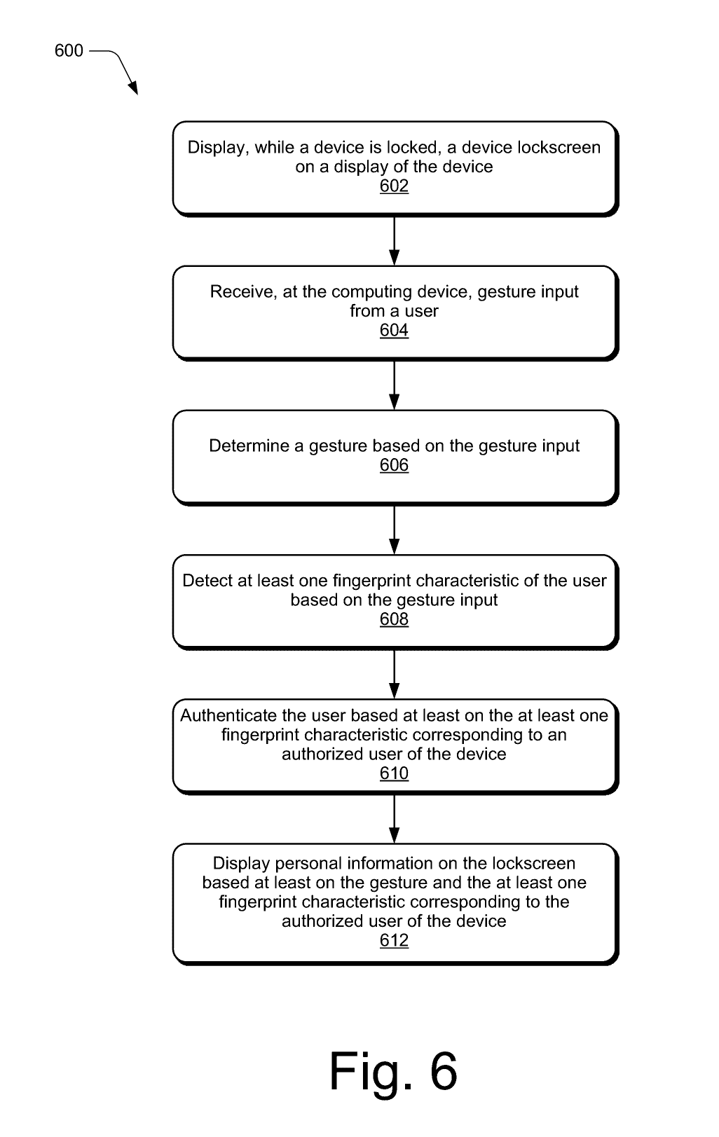

FIG. 6 illustrates an example method 600 of displaying personal information on a lockscreen based on gesture input.

At 602, a lockscreen is displayed on a display of a computing device. For example, lockscreen 126 is displayed on display 112 of computing device 102.

At 604, gesture input is received from a user at the computing device. For example, fingerprint touch sensor 118 receives gesture input 304 while device 102 is displaying lockscreen 126 in locked state 302.

At 606, a gesture is determined based on the gesture input, and at 608 at least one fingerprint characteristic of the user is detected based on the gesture input. For example, fingerprint touch sensor 118 determines a touch and hold gesture based on gesture input 304, and detects fingerprint characteristics of the user.

At 610, the user is authenticated based at least on the at least one fingerprint characteristic corresponding to an authorized user of the computing device. For example, controller 124 compares the fingerprint characteristics to stored fingerprint characteristics associated with one or more authorized users of device 102. If a match is found, controller 124 authenticates the user as an authorized user of device 102.

At 612, personal information is displayed on the lockscreen based at least on the gesture and the at least one fingerprint characteristic corresponding to the authorized user of the device. For example, controller 124 causes display of personal information 308 on lockscreen 308 based on the touch and hold gesture.

Example System and Device

FIG. 7 illustrates an example system generally at 700 that includes an example computing device 702 that is representative of one or more computing systems and/or devices that may implement the various techniques described herein. The computing device 702 may be, for example, a server of a service provider, a device associated with the client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below. Where a term is preceded with the term “statutory”, the term refers to patentable subject matter under 35 U.S.C. §101. For example, the term “statutory computer-readable media” would by definition exclude any non-statutory computer-readable media.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “communication media.”

“Computer-readable storage media” refers to media and/or devices that enable storage of information, in contrast to mere signal transmission, carrier waves, or signals per se. Thus, computer-readable storage media does not include signal bearing media nor signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to a signal-bearing medium that is configured to transmit instructions to the hardware of the computing device 702, such as via a network. Communication media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including operating system 108, controller 124, and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules as a module that is executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This is illustrated through inclusion of the controller 124 on the computing device 702. The functionality of the controller 124 and other modules may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

### CONCLUSION AND EXAMPLE IMPLEMENTATIONS

Example implementations described herein include, but are not limited to, one or any combinations of one or more of the following examples:

A computing device comprising: a display configured to display a lockscreen while the computing device is in a locked state; a fingerprint touch sensor configured to detect at least one fingerprint characteristic of a user and determine a gesture based at least on a gesture input received from the user; and a processing unit comprising a memory and one or more processors to implement a controller, the controller configured to: authenticate the user based at least on the at least one fingerprint characteristic corresponding to an authorized user of the computing device; and initiate at least one of a first responsive action or a second responsive action based at least on the gesture, the first responsive action corresponding to initiating a transition from the locked state to a first authenticated user state that displays personal information on the lockscreen without unlocking the computing device based at least on the gesture corresponding to a first gesture type, the second responsive action corresponding to initiating a transition from the locked state to a second authenticated user state based at least on the gesture corresponding to a second gesture type.

A computing device as described above, wherein the controller is configured to initiate the transition from the locked state to the second authenticated user state by opening a quick action center that enables the user to interact with the personal information and/or perform quick actions.

A computing device as described above, wherein the controller is further configured to initiate the transition from the locked state to the second authenticated user state by unlocking the computing device.

A computing device as described above, wherein the personal information is displayed on the lockscreen for a predetermined period of time after the gesture input is received.

A computing device as described above, wherein the first gesture type comprises a touch and hold gesture, and wherein the second gesture type comprises a swipe.

A computing device as described above, wherein the fingerprint touch sensor is further configured to detect gesture input to at least a portion of the display.

A computing device as described above, wherein the fingerprint touch sensor is further configured to detect gesture input to at least one of a dedicated fingerprint area or button proximate the display.

A computing device as described above, wherein prior to authenticating the user, the lockscreen does not display the personal information.

A computing device as described above, wherein the controller is further configured to prevent the transition from the locked state to the first authenticated user state and/or the transition from the locked state to the second authenticated user state based at least on the at least one fingerprint characteristic not corresponding to the authorized user of the computing device.

A computer-implemented method comprising: receiving, at a computing device, gesture input from a user while the computing device is in a locked state; determining a gesture based on the gesture input; detecting at least one biometric characteristic of the user while the gesture input is being received; authenticating the user based at least on the at least one biometric characteristic of the user corresponding to an authorized user of the computing device; and transitioning from the locked state to an authenticated user state based at least on the gesture and the at least one biometric characteristic of the user corresponding to the authorized user of the computing device.

A computer-implemented method as described above, further comprising displaying a lockscreen on a display of the computing device while the computing device is in the locked state.

A computer-implemented method as described above, wherein the transitioning from the locked state to the authenticated user state comprises displaying personal information on the lockscreen without unlocking the computing device.

A computer-implemented method as described above, wherein the lockscreen does not display the personal information until the user is authenticated.

A computer-implemented method as described above, wherein the transitioning comprises one of transitioning from the locked state to a first authenticated user state based at least on the gesture comprising a first gesture type, or transitioning from the locked state to a second authenticated user state based at least on the gesture corresponding to a second gesture type.

A computer-implemented method as described above, wherein the transitioning from the locked state to the authenticated user state further comprises one of: displaying personal information on the lockscreen without unlocking the computing device based on the gesture corresponding to a first gesture type; or unlocking the computing device based at least on the gesture corresponding to a second gesture type.

A computer-implemented method as described above, further comprising: receiving additional gesture input from the user while the computing device is in the authenticated user state; determining an additional gesture based on the additional gesture input; and transitioning from the authenticated user state to an additional authenticated user state based at least on the additional gesture.

A computer-implemented method as described above, wherein the gesture comprises one of a tap, touch and hold, or swipe, and wherein the additional gesture comprises a different one of the tap, touch and hold, or swipe.

A computer-implemented method as described above, wherein the at least one biometric characteristic comprises at least one fingerprint characteristic detected by a fingerprint touch sensor.

A computer-implemented method as described above, wherein the at least one biometric characteristic comprises at least one facial characteristic detected by a facial recognition sensor.

A computer-implemented method comprising: displaying a lockscreen on a display of a device; receiving, by a fingerprint touch sensor of the device, gesture input from the user; determining a gesture based on the gesture input; detecting at least one fingerprint characteristic of the user based on the gesture input; authenticating the user based at least on the at least one fingerprint characteristic corresponding to an authorized user of the device; and displaying personal information on the lockscreen based at least on the gesture and the at least one fingerprint characteristic corresponding to the authorized user of the device.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device comprising:
a display configured to display a lockscreen while the computing device is in a locked state;
a fingerprint touch sensor configured to detect at least one fingerprint characteristic of a user and determine a gesture based at least on a gesture input received from the user; and
a processing unit comprising a memory and one or more processors to implement a controller, the controller configured to:
authenticate the user based at least on the at least one fingerprint characteristic corresponding to an authorized user of the computing device; and
initiate at least one of a first responsive action or a second responsive action based at least on the gesture, the first responsive action corresponding to initiating a transition from the locked state to a first authenticated user state that displays personal information on the lockscreen without unlocking the computing device based at least on the gesture corresponding to a first gesture type, the second responsive action corresponding to initiating a transition from the locked state to a second authenticated user state based at least on the gesture corresponding to a second gesture type.

2. The computing device of claim 1, wherein the controller is configured to initiate the transition from the locked state to the second authenticated user state by opening a quick action center that enables the user to interact with the personal information and/or perform quick actions.

3. The computing device of claim 1, wherein the controller is further configured to initiate the transition from the locked state to the second authenticated user state by unlocking the computing device.

4. The computing device of claim 1, wherein the personal information is displayed on the lockscreen for a predetermined period of time after the gesture input is received.

5. The computing device of claim 1, wherein the first gesture type comprises a touch and hold gesture, and wherein the second gesture type comprises a swipe.

6. The computing device of claim 1, wherein the fingerprint touch sensor is further configured to detect gesture input to at least a portion of the display.

7. The computing device of claim 1, wherein the fingerprint touch sensor is further configured to detect gesture input to at least one of a dedicated fingerprint area or button proximate the display.

8. The computing device of claim 1, wherein prior to authenticating the user, the lockscreen does not display the personal information.

9. The computing device of claim 1, wherein the controller is further configured to prevent the transition from the locked state to the first authenticated user state and/or the transition from the locked state to the second authenticated user state based at least on the at least one fingerprint characteristic not corresponding to the authorized user of the computing device.

10. A computer-implemented method comprising:
receiving, at a computing device, gesture input from a user while the computing device is in a locked state;
determining a gesture based on the gesture input;
detecting at least one biometric characteristic of the user while the gesture input is being received;
authenticating the user based at least on the at least one biometric characteristic of the user corresponding to an authorized user of the computing device; and
transitioning from the locked state to an authenticated user state based at least on the gesture and the at least one biometric characteristic of the user corresponding to the authorized user of the computing device.

11. The computer-implemented method of claim 10, further comprising displaying a lockscreen on a display of the computing device while the computing device is in the locked state.

12. The computer-implemented method of claim 11, wherein the transitioning from the locked state to the authenticated user state comprises displaying personal information on the lockscreen without unlocking the computing device.

13. The computer-implemented method of claim 12, wherein the lockscreen does not display the personal information until the user is authenticated.

14. The computer-implemented method of claim 10, wherein the transitioning comprises one of transitioning from the locked state to a first authenticated user state based at least on the gesture comprising a first gesture type, or transitioning from the locked state to a second authenticated user state based at least on the gesture corresponding to a second gesture type.

15. The computer-implemented method of claim 10, wherein the transitioning from the locked state to the authenticated user state further comprises one of:
displaying personal information on the lockscreen without unlocking the computing device based on the gesture corresponding to a first gesture type; or
unlocking the computing device based at least on the gesture corresponding to a second gesture type.

16. The computer-implemented method of claim 10, further comprising:
receiving additional gesture input from the user while the computing device is in the authenticated user state;
determining an additional gesture based on the additional gesture input; and
transitioning from the authenticated user state to an additional authenticated user state based at least on the additional gesture.

17. The computer-implemented method of claim 16, wherein the gesture comprises one of a tap, touch and hold, or swipe, and wherein the additional gesture comprises a different one of the tap, touch and hold, or swipe.

18. The computer implemented method of claim 10, wherein the at least one biometric characteristic comprises at least one fingerprint characteristic detected by a fingerprint touch sensor.

19. The computer-implemented method of claim 10, wherein the at least one biometric characteristic comprises at least one facial characteristic detected by a facial recognition sensor.

20. A computer-implemented method comprising:
displaying a lockscreen on a display of a device;
receiving, by a fingerprint touch sensor of the device, gesture input from the user;
determining a gesture based on the gesture input;
detecting at least one fingerprint characteristic of the user based on the gesture input;
authenticating the user based at least on the at least one fingerprint characteristic corresponding to an authorized user of the device; and
displaying personal information on the lockscreen based at least on the gesture and the at least one fingerprint characteristic corresponding to the authorized user of the device.
